(19) United States
(12) Patent Application Publication
(10) Pub. No.: US 2014/0085485 A1
(43) Pub. Date: Mar. 27, 2014

(54) MACHINE-TO-MACHINE ENABLED IMAGE CAPTURE AND PROCESSING

(71) Applicants: Edoardo GAVITA, Laval, Quebec (CA); Nazin HOSSAIN, Brossard, Quebec (CA); Stefan Paul Redmond, Pointe-Claire, Quebec (CA)

(72) Inventors: Edoardo GAVITA, Laval, Quebec (CA); Nazin HOSSAIN, Brossard, Quebec (CA); Stefan Paul Redmond, Pointe-Claire, Quebec (CA)

(21) Appl. No.: 13/629,126

(22) Filed: Sep. 27, 2012

(51) Int. Cl. H04N 5/228; H04N 5/225

(52) U.S. Cl. 348/207.1; 348/222.1; 348/E05.024; 348/E05.031

(57) ABSTRACT

Machine-to-machine communication is employed to allow an image recording device to capture identifying information about objects in the field of view. This captured information can be stored as metadata associated with the recorded image. The metadata can be used for a number of different purposes including tagging of content to allow for classification and retrieval, as well as being used in post processing to allow for identification of particular objects based on the recorded metadata.

### TECHNICAL FIELD

This disclosure relates generally to the capturing of enhanced metadata during an image data capture process for either still images or video streams. In particular it relates to the use of machine-to-machine communications to obtain metadata for use in recording still images and video data.

### BACKGROUND

Digital video content is typically created through the use of a digital video recorder capturing a scene defined by its field of view. Due to standardization of file formats, most video capture equipment commercially available makes use of one of a few standard formats. For the following discussion, the file format defined by the Motion Picture Experts Group (MPEG) will be used for exemplary purposes.

A conventional MPEG stream is recorded by a recording device and contains at least one video stream and one audio stream. Other information related to the MPEG stream may also be recorded, such as location information, exposure data and time data. This additional information is commonly referred to as metadata and may be captured in a defined format stored within the MPEG transport stream.

An example of this is illustrated in FIG. 1. A video capture device 50 (such as a video camera, a mobile phone, or a webcam) has a field of view 52 containing objects 54a-c. The field of view 52 may be variable based on a variable length focal lens on capture device 50, or it may be fixed. The scene representing the field of view 52 is captured by device 50 as MPEG stream 56 which contains the MPEG audio and video stream 58 and metadata 60.

The metadata conventionally recorded by a capture device relates to parameters and settings in the camera. Often the time of day will be recorded based on a user set clock in the capture device 50, while a geographic location can be stored based on location data such as Global Positioning System (GPS) data provided by a GPS chipset associated with capture device 50.

When a video stream has been recorded, it is common for it to be modified or edited during a post processing step. Following such a step, the modified content is often stored (whether it be on dedicated media such as a Digital Versatile Disc (DVD), a conventional data storage device such as a hard disc drive or a sold state drive, or remotely on a file server such as a video sharing server). The post processing of the video stream can also be performed on the stored content by a service such as a video sharing service. Typically, at this time, additionally metadata such as a copyright notice or identification of the content owner is embedded in the associated metadata.

FIG. 2 is a flowchart that illustrates an exemplary method for the creation and use of metadata to a video stream as used in the prior art. In step 70, the video stream is captured, and the minimal metadata described above is recorded and associated with the video stream. In step 72, post processing is performed on the captured video stream. This post processing often involves editing of the video stream and correcting certain characteristics (such as colour balance). At this point, metadata is often added. As described above, this could be as simple as the addition of copyright information, but in some embodiments very rich data can be added. As one example, the authoring of a BluRay DVD, it is possible to embed information about elements in the video stream that can be accessed during playback. As an example, an on screen object can be identified in the metadata so that it can be clicked on during the playback of the videostream. The user, upon activating this object, is then presented with additional information, such as director commentary or plot related data.

In step 74, the post processed video stream is transmitted or stored in a readable medium that is distributed to viewers. In step 76, the user decodes and displays the video stream, and is provided access to the information in the metadata. As noted earlier this can be done in any number of different ways, including the use of a dedicated portion of the screen that displays the encoded metadata at all times, or through the use of an image map that allows the user to select object with which metadata has been associated to access the additional information.

One area in which metadata associated with objects in a video stream has taken on greater importance is the field of augmented reality. In this niche field, a mobile device, such as mobile capture device 50 of FIG. 3 is used to capture a video stream of a scene 52 containing a notable element 54d (such as a prominent architectural element). The videos stream 56 is provided to an image processing engine 62 which identifies the prominent element and making use of a data connection such as radio link 66 communicates with an online resource 66 and attempts to identify object 54d. This is done through the use of image processing techniques that are complex and computation intensive, but are otherwise outside the scope of the current discussion. The image processing may be simplified through the use of location data to reduce the number of architectural features that need to be identified. The result of the image processing is enhanced metadata 60 that can be used to enable a rich content display of videostream 56. In this display, element 54d may be highlighted and provided identification 68. Additional information may be obtainable by the user through an activation of a link in identification 68.

The use of image processing to identify objects has many advantages in that the augmented reality platform can provide information to the user that is valuable and useful. It is well understood that this sort of display technology could easily be adapted to stored content, whether it is stored on local storage or in remote storage such as a video-centric cloud storage platform. One of the problems associated with the use of image processing to identify objects as currently used in augmented reality systems is that there is a very large number of objects that need to be analysed using pattern matching algorithms in a particular captured scene. The number of objects that captured objects can be compared to can be reduced through the use of location based data. However, this reduction can only be of value if the objects being identified are specifically associated with a geographic location. This works for architectural and natural landscape features as, for example, the patterns for the Eiffel Tower are really of value only if the videostream can be identified as being captured in Paris (or conversely, are of little value if the videostream can be identified as being captured in New York City).

As the objects that are being identified become smaller and smaller, and more and more mobile, the location of the capture device becomes less relevant. This greatly increases the number of patterns that need to be identified, which renders the image processing based identification of objects in a video stream increasingly difficult.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of capturing image data with enhanced associated metadata. The method comprises the steps of issuing a request for identification of devices within proximity to a recording device, the request being transmitted through a machine-to-machine interface of the recording device; receiving a response to the issued request, the response including an identification code; and recording, at the recording device, image data and associated metadata determined in accordance with the received identification code.

In an embodiment of the first aspect of the present invention, the recorded image data is one of a video stream and a still image. In another embodiment, the request is issued over a wireless data network to a machine-to-machine application server, and the response is optionally received via the machine-to-machine application server. In another embodiment, the request is broadcast using a peer-to-peer wireless protocol.

In a further embodiment, the identification code uniquely identifies a machine-to-machine enabled device in proximity to the recording device. In another embodiment, the response includes location data associated with the received identification code. Optionally, the step of recording includes filtering the received metadata in accordance with received location data, the filtering can be performed to remove identification codes with locations outside a defined field of view of the recording device. In another embodiment, the received response includes data associated with visual properties of an object associated with the identification code.

In a further embodiment, the identification code uniquely identifies a media file. The media file may be an audio recording, while in other embodiments it may be a video recording. In some embodiments, the identification code contains a first part uniquely identifying a machine-to-machine device and a second part identifying a media file created by the uniquely identified device.

In a second aspect of the present invention, there is provided a method enhancing metadata associated with recorded image data. The method comprises the steps of processing the recorded image data to identify an object in accordance with already stored metadata associated with visual data identifying the object; and modifying the recorded image data to allow a user to access information about the identified object.

In an embodiment of the second aspect of the present invention, the step of modifying the recorded image data includes associating enhanced metadata associated with the identified object.

In a third aspect of the present invention, there is provided a recording device for capturing image data with enhanced associated metadata. The device comprises a camera, a machine to machine interface, a metadata engine and a video processor. The camera can be used to capture the image data. The machine to machine interface requests identification information associated with machine-to-machine communication devices within a determined proximity of the recording device. The metadata engine is for creating metadata in accordance with captured image data, and identification information received in response to a request issued over the machine to machine interface. The video processor instructs the machine to machine interface to issue the request for identification information, instructs the camera to capture image data, receives the captured image data form the camera and creates a content stream associating the received image data with created metadata.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustration of a prior art video capture device;

FIG. 2 is a flowchart illustrating a prior art video capture and processing method;

FIG. 3 is a block diagram illustrating the use of a video capture device in an augmented reality environment;

FIG. 4 is a flowchart illustrating a method according to an embodiment of the present invention;

FIG. 5 is a flowchart illustrating an exemplary embodiment of the method illustrated in FIG. 4;

FIG. 6 is a flowchart illustrating an exemplary embodiment of the method illustrated in FIG. 4;

FIG. 7 is a flowchart illustrating an exemplary embodiment of the method illustrated in FIG. 4;

FIG. 8 is a flowchart illustrating a method according to an embodiment of the present invention; and

FIG. 9 is a block diagram illustrating a functional representation of an exemplary device according to an embodiment of the present invention.

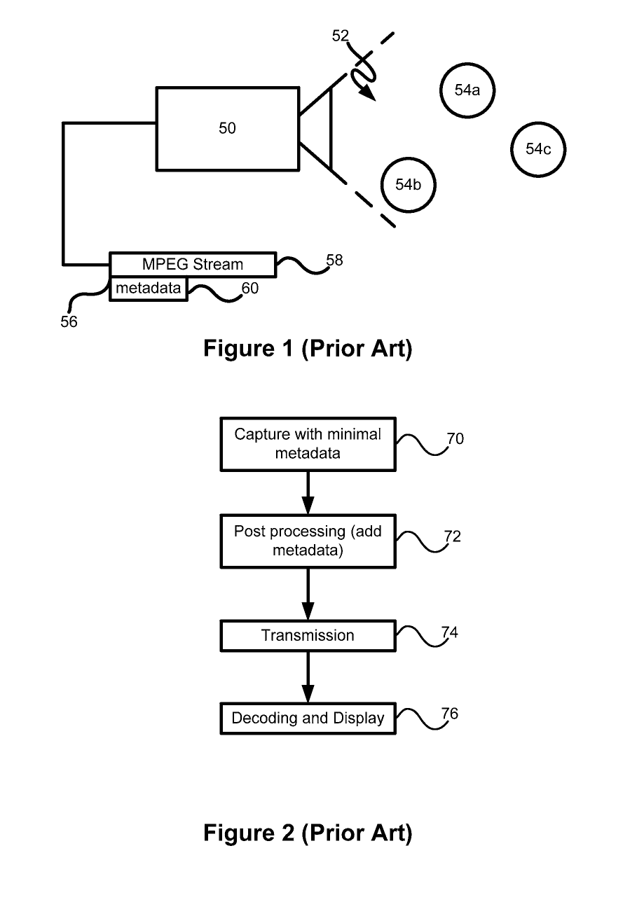

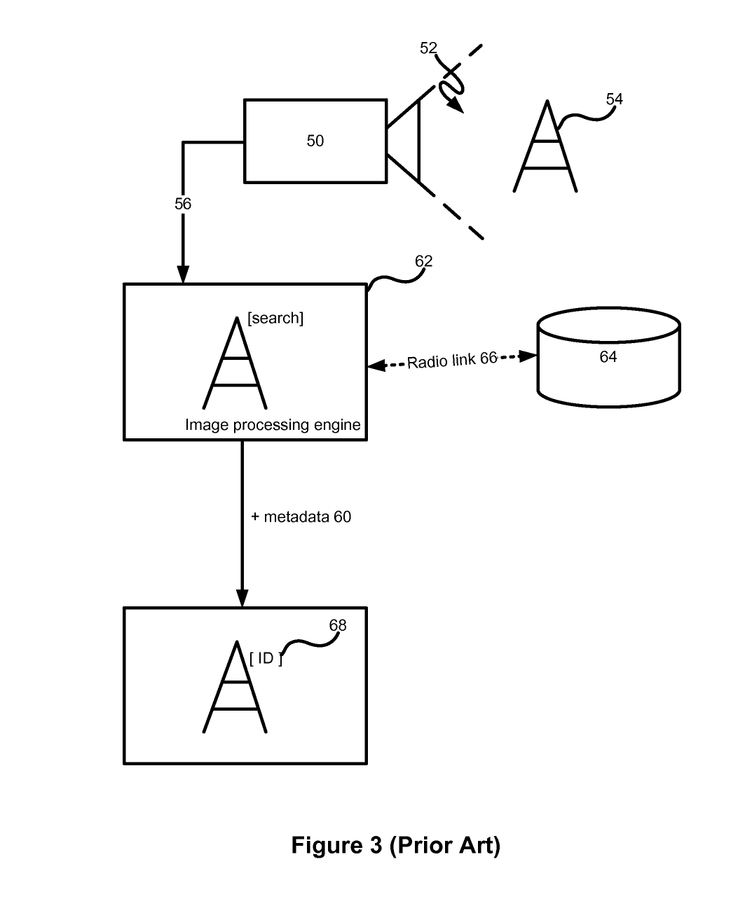

### DETAILED DESCRIPTION

The present invention is directed to a system and method for the generation of metadata during the capture of associated image data.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

As data networks, both wireless broadband networks and cellular networks, have expanded and the cost and power consumption of the chips and antennae required to access these networks have fallen, an increasingly large number of devices can access online data functions. This has given rise to an increased number of devices that support machine-to-machine (M2M) communications. M2M communications allows devices to communicate with each other, without requiring a user to initiate the communication. Typically M2M communications are short in length and exchange small programmatically readable messages that often have little value to a user.

It should be understood that M2M communications can be performed by having devices directly communicate with each other, or devices can communicate with a remote server, typically referred to as a M2M Application Server (AS). The M2M AS model of communications provides a degree of security, as a central authority can be provided that each M2M device sends information to, and then it is left to the M2M AS to serve as the gatekeeper to the information by ensuring enforcement of pre-established rules governing release of the data.

In the following discussion of a system and method, M2M communications are used to allow for the gathering and storage of metadata associated with an image or video stream. Whether the M2M communications are peer-to-peer communications or are through an M2M AS is not necessarily relevant as either system could be implemented.

As more M2M devices become available, the cost and size of the devices becomes much lower. It is envisioned that many objects can be embedded with dedicated M2M devices solely for the purposes of identification. During the recording process, an image capture device can issue a request for identification of all M2M devices associated with elements in the camera field of view. This identification information could be as limited as an identification code that can be used to retrieve further information about the object, or it could be as rich as data identifying the object, its manufacturer and other relevant information. This data can be sent to the image capture device either through a direct device to device communication or through an M2M AS. The identification information can be captured and stored in the metadata associated with the captured image or video. Thus, a rich metadata stream can be created during the recording process that can obviate or mitigate the problems of creating metadata during a post processing stage.

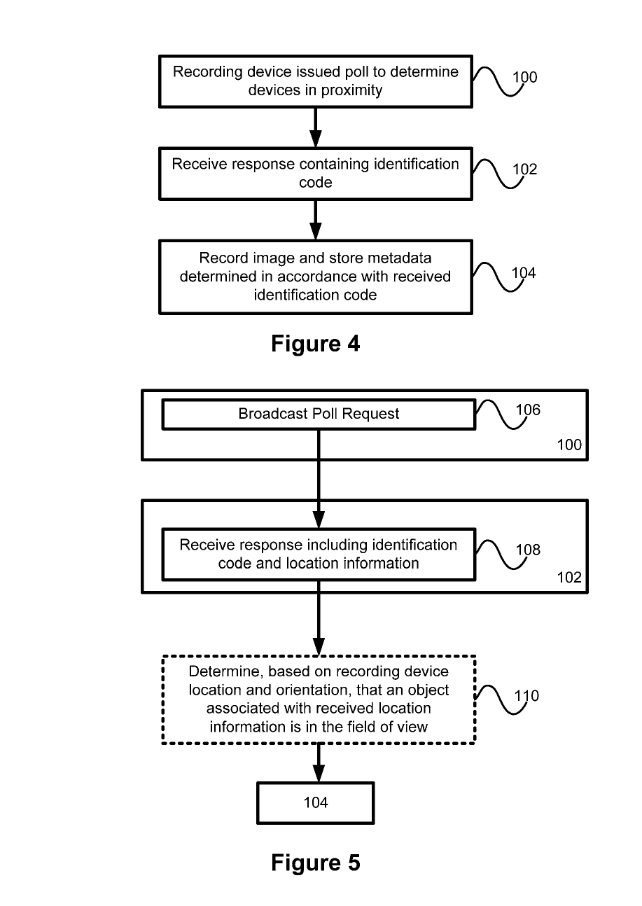

FIG. 4 illustrates an exemplary embodiment of such a method. In step 100, the recording device, which in different embodiments could be a video capture device or a still image capturing device, issues a poll to determine identification information from any M2M device in the field of view of the recording device. In step 102, the recording device receives a response from and M2M device containing an identification code. In step 104, the recording device records the image and stores metadata associated with the M2M device. The metadata is preferably determined in accordance with the received identification code. As will be discussed in more detail below, the metadata may be as simple as the received identification code, or it could be information retrieved from an online repository that is associated with the identification code.

FIG. 5 illustrates an exemplary embodiment of the method of FIG. 4. To carry out step 100, a poll request is broadcast 106 to all devices within a defined range of the recording device. As a part of step 102, a response to the poll request is received that includes an identification code and location information associated with an M2M device enabled object as shown in step 108. In optional step 110, the recording device can determine, in accordance with a device location and orientation, that an object associated with the M2M device is within the field of view based on the reported location of the object. Upon making the determination in step 110, the method can proceed to step 104 as described above. One skilled in the art will appreciate that if a number of different devices respond to the poll, the recording device may elect to only record metadata information for the devices having a location within the field of view.

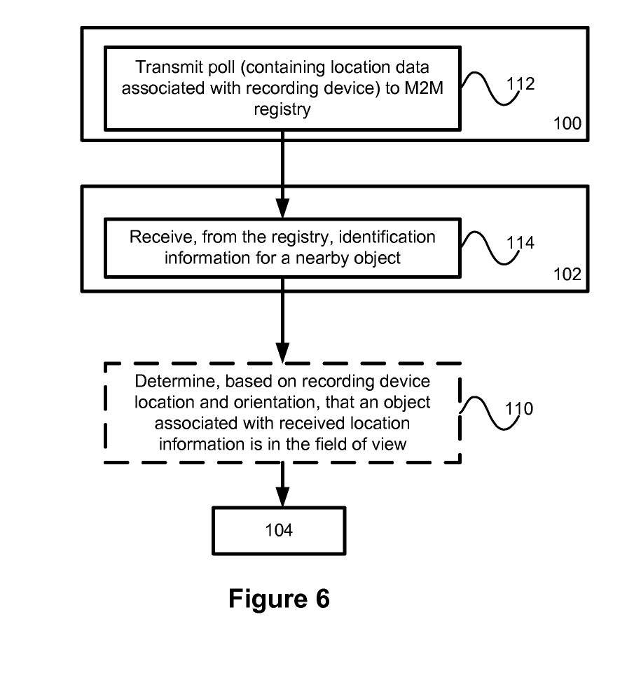

FIG. 6 illustrates an alternate embodiment in which an M2M AS registry is employed. As will be apparent to those skilled in the art, it is common for M2M devices that make use of a central M2M AS to report information, such as location information to the M2M AS for storage in a registry. This facilitates the retrieval of information without requiring the direct involvement of the M2M device. In carrying out step 100, the recording device can transmit a poll request to the M2M registry (typically through an M2M AS). This poll request will interrogate the registry to obtain a listing of M2M devices in proximity to the recording device, and thus will typically include location data associated with the recording device) as shown in step 112. In carrying out step 102, the recording device, as shown in step 114, will receive identification information for an object in proximity to the recording device. The identification information may, in some embodiments, be supplemented with other information such as specific location information that can be used in an optional step such as step 110 as discussed above with respect to FIG. 5. Upon receipt of the information in step 114, which is typically received from the M2M registry, either directly or indirectly, the process continues to step 104.

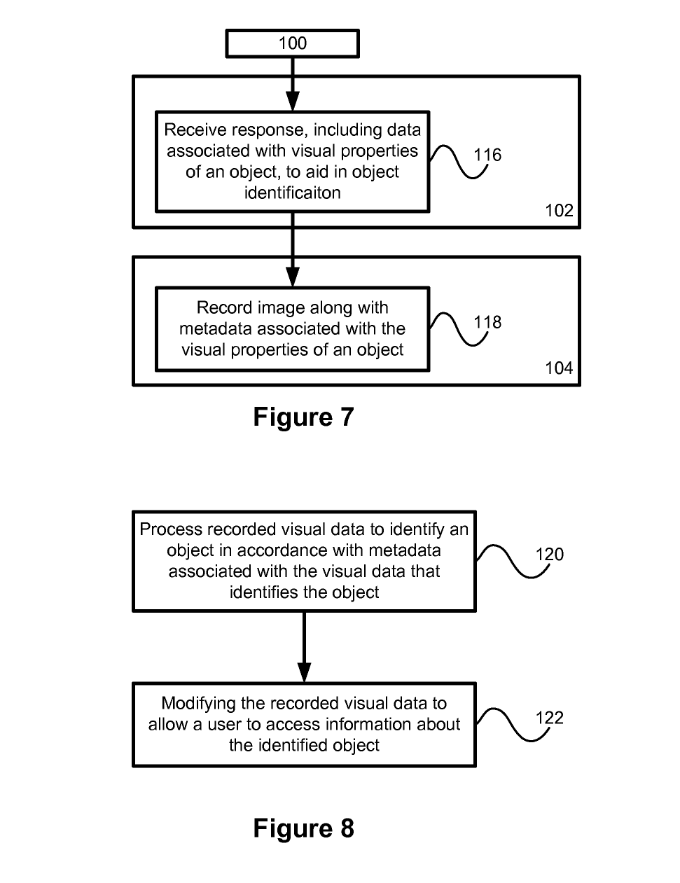

FIG. 7 illustrates a further exemplary method. Following step 100, and as a part of step 102, the recording device receives a response that includes data associated with visual properties of an object in step 116. These visual properties are preferably sufficient to allow an object to be identified during a post-processing image analysis step carried out after recording. As part of step 104, and as illustrated in step 118, the recording device records the image along with metadata associated with the received visual properties. It should be understood that this exemplary method could be enhanced through the use of optional step 110 above to further restrict the number of elements for which visual cues are recorded.

One skilled in the art will appreciate that there are advantages to being able to record a still or moving image that has embedded information about the contents of the image. As one example, if monuments and buildings make use of an M2M device infrastructure, it would be possible for a person to record an image, and have the prominent architectural elements identified. Afterwards, a simple query could be performed in a content management system to identify all the images or videos that include, for example, the Eiffel Tower. If the identification information is properly received and recorded as described above, the recorded content will be easily retrieved without requiring the user to apply tags to recorded content. However, if an M2M device is attached to something smaller and more portable, such as a motorcycle, it would be possible to easily identify all recorded content (again either still images or captured video) that had the particular model of motorcycle. Those skilled in the art will appreciate that a number of such advanced features can be enabled through the use of the above described methods.

FIG. 8 illustrates a method of post processing using the metadata recorded using the above described methods. In step 120, the recorded visual data is processed to identify an object that is represented in the visual data. This processing is performed in accordance with metadata associated with the recorded visual data that identifies the object. In step 122, the recorded visual data is modified to allow a user to access information associated with the identified object.

With reference to FIG. 8, it will be understood that conventional image processing techniques may be relied upon to identify large monuments and other architectural features because their structure is well known, and because the number of patterns to be used in a pattern matching algorithm can be limited by the geographic location of the recording device. However, smaller objects, such as an article of clothing, are typically not able to be identified because building a sufficiently large database of items would result in too many objects in the pattern database. However by identifying the objects in a recording, at the time of the capture, which may be supplemented with metadata related to the visual characteristics of the object, the ability of an image processing engine to identify objects is greatly increased.

It will be understood that if an object identifier is obtained during the recording process, during a post processing or playback stage, it should be understood that the identifier of an object may be used to obtain live information about the object. As an example, when a recording is made and metadata associated with an architectural feature is recorded, during post processing the object identifier can be used to access object pattern characteristics to allow for post processing identification of the object even if visual properties have not been recoded in the metadata. Upon identification of the object, the identifier can remain in the metadata so that during playback, the viewer can obtain real-time information about the object. As an example, if an identifier is obtained during the recording process and is then stored in metadata, during a post processing phase the captured image can be identified based on properties of the object retrieved based on the identifier. Thus, an identifier associated with the Washington monument could provide post-processing data allowing for identification of the monument. During a user viewing of a video, the identifier could be associated with the regions of a display that correspond to the Washington Monument. The viewer could then obtain real-time information about the Washington Monument (e.g. hours of operation, live weather, etc.) that would not be suitable for recording in the metadata. This multi-layered approach to recording metadata during capture, identification of objects and enhancing the metadata during post processing, and then obtaining up-to-date real-time data about the object can provide a level of depth in enhanced data that was previously unavailable.

One skilled in the art will appreciate that the above described metadata capture and processing methods can be implemented during the capture of still images, during the recording of video images and during display of live captured images as would be used in augmented reality applications. It should also be understood that in an M2M environment the M2M devices identifying objects in the recorded image can be used for more than just identification purposes. In some embodiments, prior to reporting identification information to the recording device, the M2M device can determine whether it should provide a response at all, and it may track identification information allowing the device to know which recording devices have interacted with it. In an exemplary embodiment, an M2M device may be a device uniquely associated with a person, such as a mobile phone. When it is interrogated by a recording device, it may determine that the recording device is associated with a known person and thus provide identification information that is associated with its owner. This could provide an automated “tagging” service identifying the people in the photograph or video. However if the recording device belongs to a stranger, it may be advantageous to not reply. The M2M device could store information about how it has been recorded, and by whom. This would allow the owner of the M2M device to find the photographs or recorded video content in which he appears.

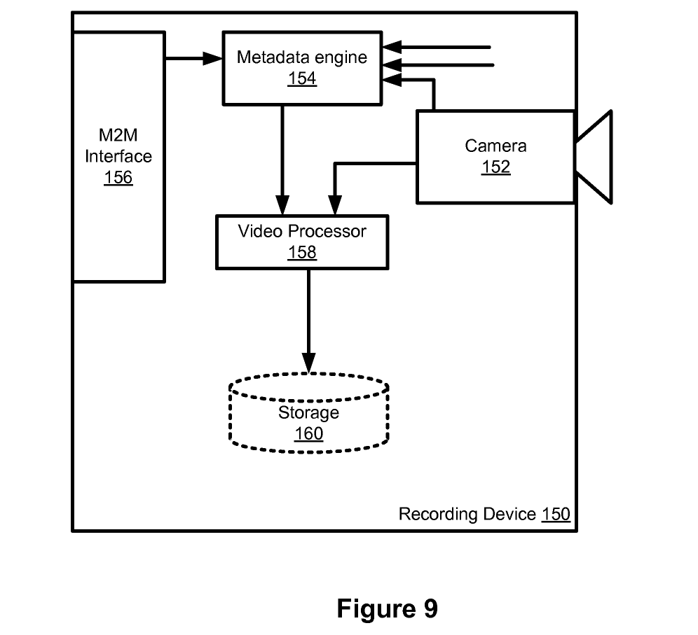

FIG. 9 is a block diagram illustrating an exemplary recording device 150 according to an embodiment of the present invention. Recording device 150 includes a video processor 158 which serves to control other included elements. Video processor 158 can issue instructions to camera 152 to capture image data (either still images or a video stream). Captured image data is provided back to video processor 158. Camera 152 can also provide information about the image data and image capture settings to metadata engine 154. Video processor 158, can also instruct M2M interface 156 to issue requests for identification of other M2M devices within proximity to recording device 150. The responses received by M2M interface 156 can be provided as inputs to metadata engine 154 along with other data such as time and location data. The metadata engine 154 can filter data from its various inputs to create a consolidated metadata stream that is provided to video processor 158. Video processor 158 can then create metadata enriched content by combining the output of camera 152 and metadata engine 154. This content stream can either be transmitted to another device or stored locally in optional storage 160.

In another exemplary embodiment, recording device 150 can be used in a venue where other devices are recording. It is a common problem with lower cost video recording equipment that the audio recording functions are not up to professional grade. Instead of requiring a dedicated audio capture device, recording device 150 can issue an M2M polling request (over M2M interface 156) and determine that there is an audio recording device present. Identification and synchronization information for both the audio device and the audio stream that it is recording can be stored in the metadata associated with a captured video stream. During post processing the identification of an external audio stream can be used to obtain a better quality audio signal to replace any audio recorded by recording device 150.

Those skilled in the art will also appreciate that recording device 150 can also receive polling requests from other similar devices 150. In responding to such a request, recording device 150 can provide identification of both the device and the content stream that it is recording. This could be accomplished by providing a locally unique identification token in the metadata of each recording. The combination of a unique device identifier and a locally unique media identifier would uniquely identify the recorded content. When identification of other recordings is stored in the metadata, it enables a viewer to perform a search for any content uploaded to a particular resource, such as a public video sharing site, that was taken in the same area at the same time. It is thus envisioned that a recording device at a live concert could store metadata identifying an audio recording of the event as well as for identifying other video recordings. In post processing the audio could be enhanced through accessing the recorded audio (which may involve paying for access to the improved audio), and at the same time facilitate finding different recording angles of the same event.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of capturing image data with enhanced associated metadata, the method comprising:
issuing a request for identification of devices within proximity to a recording device, the request being transmitted through a machine-to-machine interface of the recording device;
receiving a response to the issued request, the response including an identification code; and
recording, at the recording device, image data and associated metadata determined in accordance with the received identification code.

2. The method of claim 1 wherein the recorded image data is a video stream.

3. The method of claim 1 wherein the recorded image data is a still image.

4. The method of claim 1, wherein the request is issued over a wireless data network to a machine-to-machine application server.

5. The method of claim 4 wherein the response is received via the machine-to-machine application server.

6. The method of claim 1, wherein the request is broadcast using a peer-to-peer wireless protocol.

7. The method of claim 1 wherein the identification code uniquely identifies a machine-to-machine enabled device in proximity to the recording device.

8. The method of claim 1 wherein the response includes location data associated with the received identification code.

9. The method of claim 8 wherein the step of recording includes filtering the received metadata in accordance with received location data.

10. The method of claim 9 wherein the filtering removes identification codes with locations outside a defined field of view of the recording device.

11. The method of claim 1 wherein the received response includes data associated with visual properties of an object associated with the identification code.

12. The method of claim 1 wherein the identification code uniquely identifies a media file.

13. The method of claim 12 wherein the media file is an audio recording.

14. The method of claim 12 wherein the media file is a video recording.

15. The method of claim 12 wherein the identification code contains a first part uniquely identifying a machine-to-machine device and a second part identifying a media file created by the uniquely identified device.

16. A method of enhancing metadata associated with recorded image data, the method comprising:
processing the recorded image data to identify an object in accordance with already stored metadata associated with visual data identifying the object; and
modifying the recorded image data to allow a user to access information about the identified object.

17. The method of claim 16 wherein the step of modifying the recorded image data includes associating enhanced metadata associated with the identified object.

18. A recording device for capturing image data with enhanced associated metadata, the device comprising:
a camera for capturing the image data;
a machine to machine interface for requesting identification information associated with machine-to-machine communication devices within a determined proximity of the recording device;
a metadata engine for creating metadata in accordance with captured image data, and identification information received in response to a request issued over the machine to machine interface; and
a video processor for instructing the machine to machine interface to issue the request for identification information, for instructing the camera to capture image data, for receiving the captured image data form the camera and for creating a content stream associating the received image data with created metadata.
